(19) United States
(12) Patent Application Publication
(10) Pub. No.: US 2004/0108170 A1
(43) Pub. Date: Jun. 10, 2004

(54) Elevator installation and method of arranging a drive motor of an elevator installation

(76) Inventors: Johannes Kocher, Udligenswil (CH); Marco Hoerler, Gordola (CH); Michael Schmid, Stans (CH)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/656,665

(22) Filed: Sep. 5, 2003

(30) Foreign Application Priority Data
Sep. 5, 2002 (EP) 02405768.9

(51) Int. Cl. B66B 11/08

(52) U.S. Cl. 187/254; 187/264; 187/266

(57) ABSTRACT

An elevator installation and a method of arranging a drive motor for moving a car and a counterweight in a shaft includes mounting the drive motor on a crossbeam fastened at end regions to a pair of counterweight guides and fastened at a center region to at least one car guide.

### BACKGROUND OF THE INVENTION

The present invention relates to an elevator installation and to a method of arranging a drive motor of an elevator installation.

An elevator installation in which a drive motor drives a car and a counterweight by way of a drive cable and which elevator installation does not require a separate motor room is known from Japanese Utility Model JP-50297/1992. Two vertical columns in the form of self-supporting U-shaped profile members serve as guide for the car and the counterweight. The columns are closed at the upper end thereof by a horizontal crossbeam, on which the drive motor is mounted. This elevator installation has the advantage of lower production costs due to the elimination of the motor room.

European Patent EP-1045811 shows an elevator installation in which a crossbeam carrying the drive motor is fastened to a total of four guides for the car and the counterweight. In this manner the entire vertical weight force of the drive motor, the car and the counterweight is conducted exclusively by way of these guides to the shaft floor and supported there. In that case economic, conventional guides find use. Added to that is the further advantage that the drive motor does not exert any bending moments on the supporting guides, since by virtue of this arrangement and fastening only vertical forces act on the guides. A disadvantage of this elevator installation is the restriction of the arrangement of the drive motor to the lateral shaft region in which the guides extend.

### SUMMARY OF THE INVENTION

The present invention concerns an elevator installation having a car and a counterweight connected by a drive means and movable in a shaft comprising: a pair of car guides adapted to be mounted in the shaft; a pair of counterweight guides adapted to be mounted in the shaft; a crossbeam attached to the counterweight guides and to at least one of the car guides; and a drive motor mounted on the crossbeam and coupled to a pair of drive pulleys adapted for engaging the drive means to move the car and the counterweight in the shaft. The drive pulleys are arranged on opposite sides of an imaginary line horizontal connector of the car guides and are operatively connected by a shaft with the drive motor and a brake. The drive pulleys can be arranged between the drive motor and the brake on the shaft. The drive motor and brake can be mounted on a bracket fastened to the crossbeam.

An object of the present invention is to provide an elevator installation with a flexible arrangement of the drive motor. The drive motor is to be arranged freely and selectably substantially in the overall shaft region above the car and the counterweight. The drive motor is to be arranged in a space-saving manner and to be of small dimensions.

The present invention relates to an elevator installation with a car and a counterweight in a shaft. It comprises a drive motor mounted on a crossbeam. The crossbeam is fastened by way of each of two end regions at a respective counterweight guide and it is fastened by a center region to at least one car guide.

The two counterweight guides and one car guide span a substantially horizontal triangle in the shaft. The drive motor is of elongate and compact form. Advantageously the drive motor comprises two drive pulleys, which are arranged symmetrically to the left and right of a horizontal connector of the car guides.

By virtue of this arrangement, which is symmetrical in the triangle, of the guides, weight forces of the drive motor as well as bending moments arising during operation of the drive motor are effectively absorbed and conducted by way of the crossbeam and the guides to the shaft floor. The drive motor can be arranged freely and selectably on the area of this triangle substantially above the counterweight and/or substantially above the car. This flexibility with respect to the arrangement of the drive motor is made possible by the size and shape of the crossbeam and/or the number of deflecting rollers used and/or the kind of drive means employed.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic plan view of a triangular arrangement of guides of an elevator installation;

FIG. 2 is a perspective view of a first embodiment of the arrangement of a drive motor above the counterweight according to the present invention;

FIG. 3 is a schematic plan view of the arrangement of the drive motor shown in FIG. 2;

FIG. 4 is a schematic elevation view of the arrangement of the drive motor shown in FIGS. 2 and 3;

FIG. 5 is a schematic plan view of a second embodiment of the arrangement of a drive motor above the counterweight and/or the car according to the present invention;

FIG. 6 is a schematic elevation view of the arrangement of the drive motor shown in FIG. 5;

FIG. 7 is a schematic plan view of a third embodiment of the arrangement of a drive motor above the car according to the present invention;

FIG. 8 is a schematic elevation view of the arrangement of the drive motor shown in FIG. 7;

FIG. 9 is a schematic plan view of a fourth embodiment of the drive motor above the car according to the present invention; and

FIG. 10 is a schematic elevation view of the arrangement of the drive motor shown in FIG. 9.

### DESCRIPTION OF THE PREFERRED EMBODIMENT

FIG. 1 shows a schematic illustration of the triangular arrangement of guides 5, 5′, 9, 9′ of an elevator installation in which a drive is to be arranged in accordance with the present invention. The elevator installation is arranged in, for example, a substantially vertical shaft 10. The shaft 10 has, for example, a rectangular cross-section with four walls. Substantially vertically arranged car guides 5, 5′ and counterweight guides 9, 9′ are fastened in the shaft. Two car guides guide a car 11 and two counterweight guides guide a counterweight 12. The guides are fastened to adjacent walls. The two counterweight guides 9, 9′ and a first car guide 5 are fastened to a first wall. A second car guide 5′ is fastened to a second wall. The second wall is disposed opposite the first wall. The first car guide 5 is arranged substantially centrally between the two counterweight guides 9, 9′. The guides 5, 5′, 9, 9′ are formed of materials typically used in elevator installations, such as steel. The fastening of the guides to the walls is carried out by way of, for example, screw connections (not shown). With knowledge of the present invention, a person of ordinary skill in the elevator field could select other shaft geometry with square, oval or round cross-section used.

The two counterweight guides 9, 9′ and in each instance one of the two car guides 5, 5′ form, in the shaft 10, substantially horizontal triangles T, T′ respectively. The imaginary line horizontal connector between the two counterweight guides 9, 9′ forms a first side of both of the triangles. The imaginary line horizontal connectors between each counterweight guide and the car guide 5′ form second and third sides of the triangle T. Advantageously, the horizontal connector between the counterweight guides 9, 9′ is longer than each of the horizontal connectors to the car guide 5, so that the triangle T consisting of guides 9, 9′, 5 at the first wall has an obtuse angle opposite the horizontal connector of the counterweight guides 9, 9′. The horizontal connector of the counterweight guides 9, 9′ is shorter than the horizontal connectors to the car guide 5′, so that the triangle T′ consisting of the counterweight guides 9, 9′ at the first wall and the car guide 5′ at the second wall has an acute angle opposite the horizontal connector of the counterweight guides 9, 9′. Advantageously the horizontal connector of the car guides 9, 9′ intersects the horizontal connector of the counterweight guides 5, 5′ substantially centrally so that the triangles T, T′ are substantially equilateral.

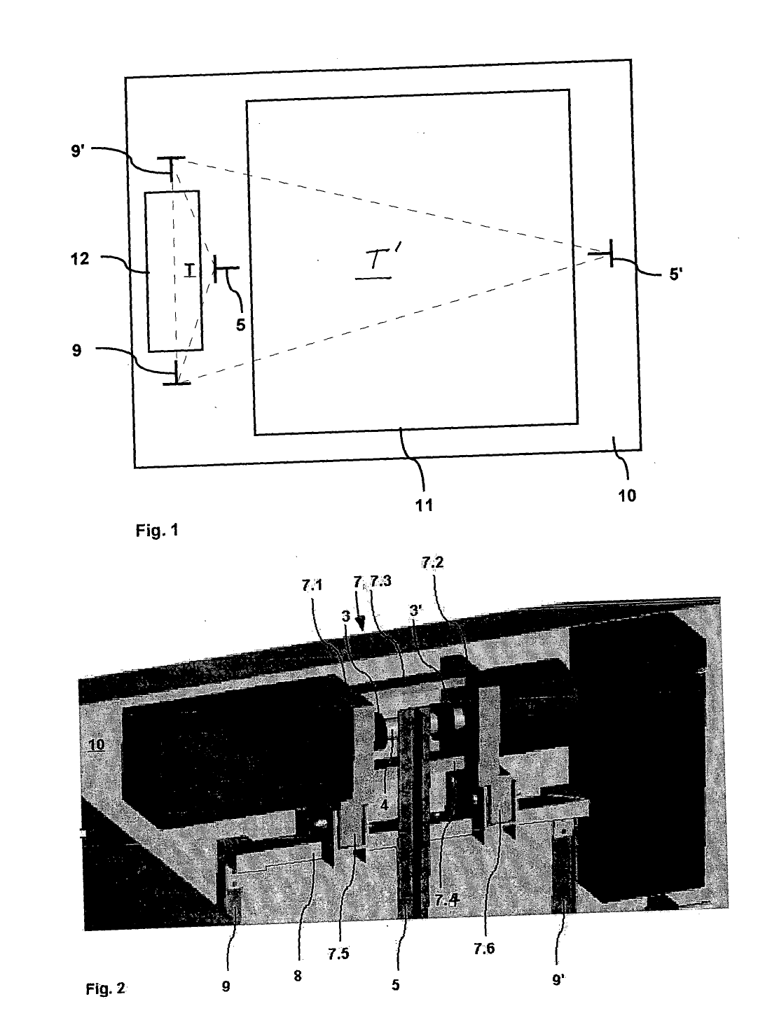

FIGS. 2 to 10 show a drive motor 1, 1′ with two drive pulleys 3, 3′. Advantageously the drive pulleys 3, 3′ are operatively connected by way of a shaft 4, 4′ with the motor 1, 1′ and a brake 2, 2′. Advantageously, the motor and the brake are arranged at opposite ends of the shaft and the drive pulleys are arranged between motor and brake in a central region of the shaft. A control and/or a transformer of the elevator installation is/are arranged in a switch box 6 advantageously at a wall of the shaft 10. In the embodiments according to FIGS. 2 to 8 the drive motor 1 is gearless and of elongate form, i.e. the diameter of the drive motor as seen in a plane perpendicular to the axis of the shaft 4 is smaller than the length of the drive motor. In the embodiment according to FIGS. 9 and 10, the drive motor 1′ is provided with a gear 40. In this form of embodiment as well, the drive motor 1′ is of elongate form, i.e. the diameter of the drive motor as seen in a plane perpendicular to the axis of the gear 40 is smaller than the length of the drive motor.

Advantageously, the two drive pulleys 3, 3′ are arranged symmetrically to the left and right of a horizontal connector of the car guides 5, 5′. The drive pulleys 3, 3′ are advantageously smaller in diameter than the motor housing and/or the brake housing.

The drive motor 1, 1′ arranged substantially horizontally in the shaft 10 drives the car 11 and the counterweight 12, which are interconnected by way of at least one drive means 19, 19′ in the shaft. The drive means 19, 19′ has two ends 18, 18′. The drive means 19, 19′ is a cable and/or a belt of any form. The load-bearing regions of the drive means consist of metal, such as steel and/or plastic material, such as aramide. The cable can be a single cable or multiple cable and the cable can also have an external protective sheathing of plastic material. The belt can be flat and externally unstructured and smooth or, for example, can be structured into wedge ribs or cogged belts. Advantageously two drive means are employed 19, 19′.

Each of the ends 18, 18′ of the drive means 19, 19′ is fixed to a shaft wall or a shaft ceiling or a car guide or a counterweight guide or a crossbeam 8 or to the car 11 or to the counterweight 12. Advantageously, the ends 18, 18′ of the drive means are fixed by way of resilient intermediate elements for damping of solid-borne sound. The intermediate elements are, for example, spring elements which prevent transmission of vibrations, which are perceived to be unpleasant, from the drive means to the shaft wall and/or the shaft ceiling and/or the car guide and/or the counterweight guide and/or the crossbeam and/or the car and/or the counterweight. Several exemplary forms of fixings of the ends of the drive means can be distinguished as follows:

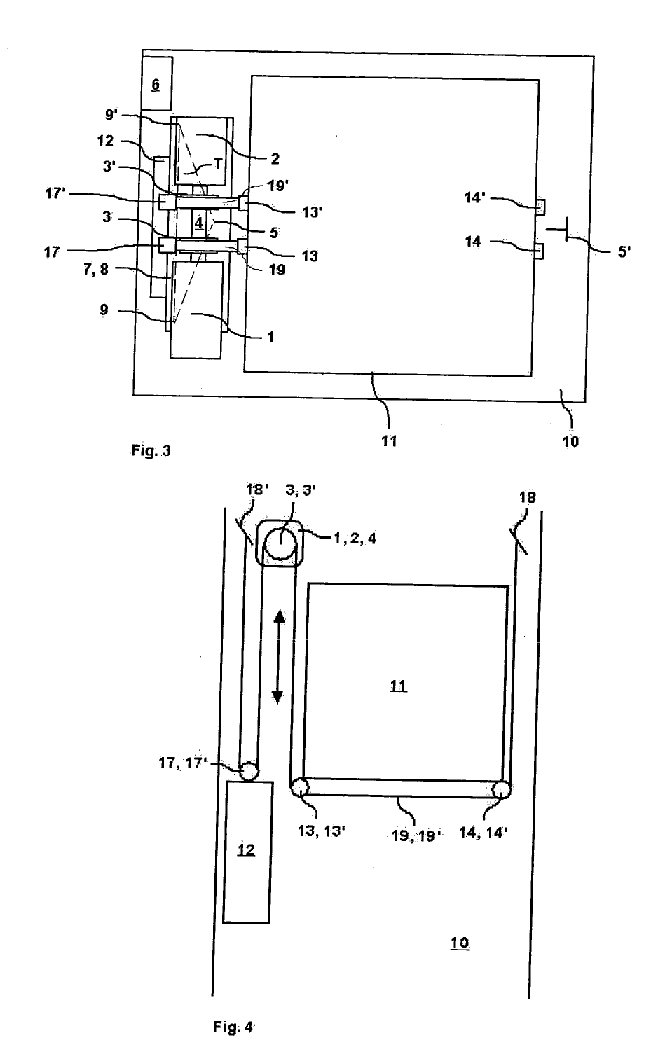

In the embodiment according to FIGS. 3 and 4, the first end 18 of the drive means is fastened to the shaft wall or the shaft ceiling or the car guide 5′ and the second end 18′ of the drive means is fastened to the shaft wall or the shaft ceiling or the crossbeam 8 or the car guide 5.

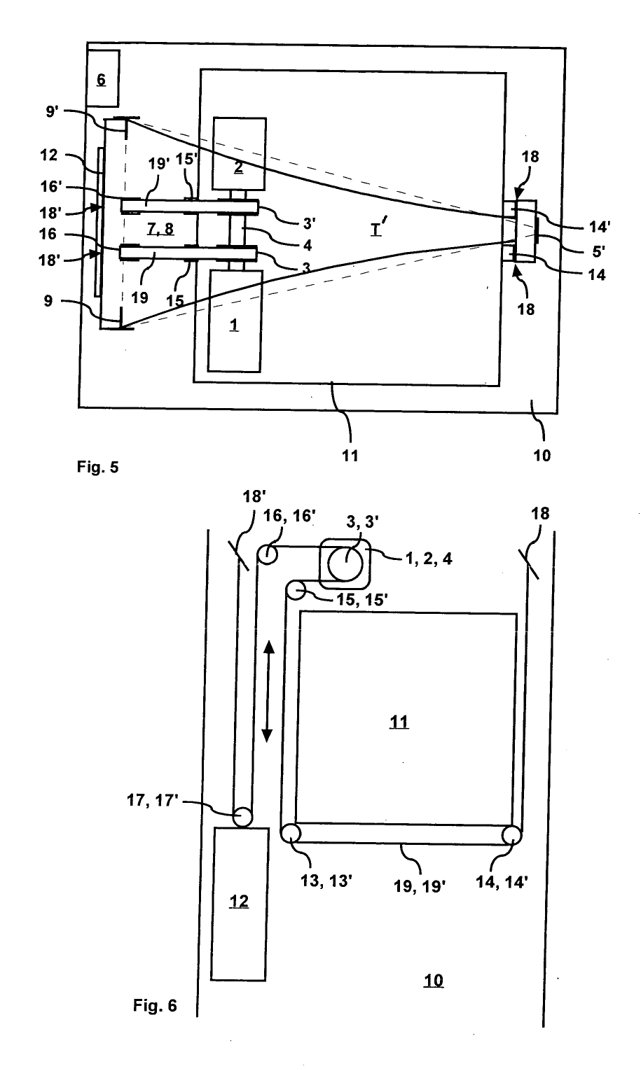

In the embodiment according to FIGS. 5 and 6 as well as FIGS. 9 and 10, one or both ends 18, 18′ of the drive means is or are fastened to the shaft wall or the shaft ceiling or the car guide or the crossbeam.

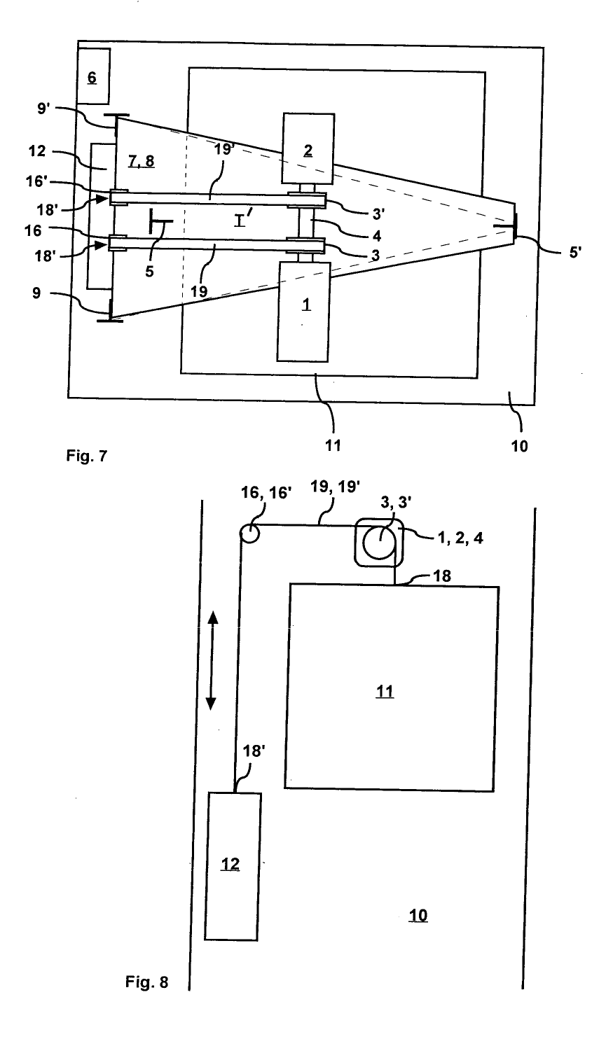

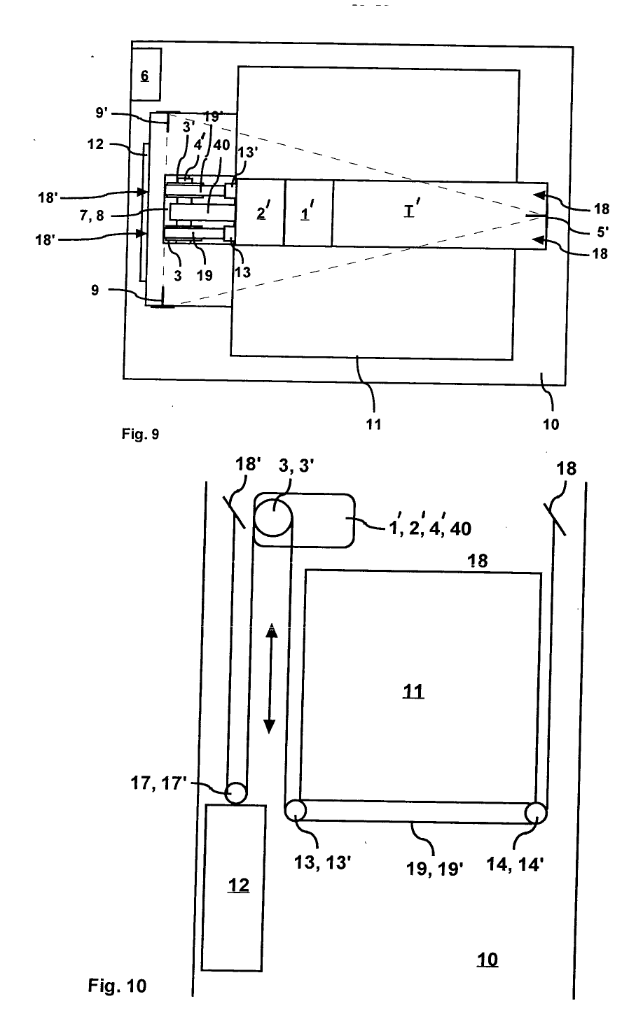

In the embodiment according to FIGS. 7 and 8, the first end 18 of the drive means is fastened to the car 11 and the second end 18′ is fastened to the counterweight 12.

According to the embodiments shown, two drive pulleys move two drive means by way of friction couple. With knowledge of the present invention the expert can also use drive motors as well as drive means different from the examples. Thus, the expert can use a drive motor with only one drive pulley or with more than two drive pulleys. In addition, the expert can use a drive pinion, which drive pinion is in mechanically positive engagement with a cogged belt, as the drive means.

Several exemplary forms of suspensions can be distinguished:

In the first embodiment according to FIGS. 2 to 4, in the second embodiment according to FIGS. 5 and 6 and in the fourth embodiment according to FIGS. 9 and 10, the car 11 and the counterweight 12 are suspended with a 2:1 ratio. In the case of the 2:1 suspension of the car 11, several deflecting rollers 13, 13′, 14, 14′ are mounted on the car 11. In the case of the 2:1 suspension of the counterweight 12, at least one deflecting roller 17, 17′ is mounted at the counterweight 12. Advantageously, in the first embodiment the drive motor 1 is arranged in a region substantially above the travel path of the counterweight 12, i.e. in the vertical projection above the counterweight. In the second embodiment the drive motor 1 is advantageously arranged in a region substantially completely above the travel path of the car 11. Advantageously, in the fourth embodiment the drive motor 1′ is arranged in a region substantially above the travel path of the counterweight 12 and the car 11, i.e. in the vertical projection above the counterweight and the car.

In the third embodiment according to FIGS. 7 and 8, the car 11 and the counterweight 12 are suspended with a 1:1 ratio. Advantageously, the drive motor 1 in the third embodiment is arranged in a region substantially above the travel path of the car 11, i.e. in the vertical projection above the car. The drive motor 1 in the third embodiment is advantageously arranged completely above the travel path of the car 11.

FIG. 2 shows a perspective view of the first embodiment of the arrangement of a gearless drive motor 1. The drive motor 1 is mounted on the crossbeam 8 arranged substantially horizontally in the shaft 10. The crossbeam 8 is, for example, an elongate rectangle of proven materials, such as steel. In this first embodiment, the crossbeam 8 is fastened to the counterweight guides 9, 9′ and to the car guide 5 at the first wall of the shaft 10. Advantageously the crossbeam 8 is fastened by way of two end regions to the counterweight guides and by way of a center region to the car guide. The fastening of the crossbeam to these three guides takes place in the three fastening regions by way of, for example, screw connections.

Advantageously the drive motor 1 is mounted on the crossbeam 8 indirectly by way of a bracket 7. The bracket 7 is advantageously mounted at the center region of the crossbeam 8. For example, the bracket 7 is mounted on the crossbeam 8 by way of feet 7.5, 7.6. The bracket 7 consists of, for example, a flat-edge or square member of proven materials, such as steel, and is mounted on the crossbeam 8 by way of, for example, screw connections. Advantageously the drive motor 1 is fastened to the bracket 7 by way of a motor housing and a brake housing. The motor housing is advantageously fastened to a first bracket mount 7.1 and the brake housing to a second bracket mount 7.2. The two bracket mounts 7.1, 7.2 are connected together by way of, for example, struts 7.3, 7.4 to be stiff in bending with respect to the axis of the shaft 4. Advantageously, the bracket mounts 7.1, 7.2 embrace, at least regionally, boundaries of the motor housing or the brake housing. For example, the bracket mounts 7.1, 7.2 embrace end faces of the motor housing or the brake housing. Advantageously, the motor 1 and the brake 2 are arranged in a region substantially outside an enclosure of the bracket 7, whilst the drive pulleys 3, 3′ are arranged in a region substantially within the enclosure of the bracket 7.

The crossbeam 8 is fastened at least to the apices of the triangle T. Advantageously, the crossbeam 8 rests by two end regions on the counterweight guides 9, 9′ and it bears by the center region laterally against the car guide 5.

Distinction can be made between several exemplary embodiments of crossbeam fastenings:

In the embodiment according to FIGS. 2 to 4—where the drive motor is arranged in a region substantially above the travel path of the counterweight—the crossbeam 8 is fastened to the counterweight guides 9, 9′ and to the car guide 5 at the first wall, which lies closest to the counterweight guides 9, 9′ as well as the car guide 5. The crossbeam has the form of a rectangle.

In the embodiments of FIGS. 2 to 10—where the drive motor 1, 1′ is arranged in a region substantially above the travel path of the counterweight or the car—the crossbeam 8 is fastened to the counterweight guides 9, 9′, to the car guide 5 of the first wall and/or to the car guide 5′ of the second wall. The crossbeam 8 has, in the examples of the embodiments according to FIGS. 5 to 8, a triangular form with straight or curved sides and in the example of the embodiment according to FIGS. 9 and 10 a T-shape.

The bracket 7 and the drive pulleys 3, 3′ are advantageously arranged in a central region of the triangles T, T′. Advantageously, the bracket 7 is mounted at the center region of the crossbeam 8. For example, in the first embodiment according to FIG. 2 the feet 7.5, 7.6 of the bracket 7 are mounted at the crossbeam 8 on opposite sides of the car guide 5 and substantially equally spaced from the car guide. For example, the drive pulleys 3, 3′ are arranged on the shaft 4 on opposite sides of the car guide 5 and substantially equally spaced from the car guide.

The drive motor 1, 1′ can thus be freely selectably arranged on the area of the triangles T, T′ substantially above the counterweight and/or substantially above the car. By virtue of this arrangement, which is symmetrical in the triangles T, T′, of the guides, weight forces of the drive motor as well as bending moments arising during operation of the drive motor are effectively absorbed by, for example, the bracket 7 and conducted by way of the crossbeam 8 and the guides to the shaft floor. The guides are supported, for example, by way of foot plates (not shown) on the shaft floor.

For example, in the embodiment according to FIG. 2 the first bracket mount 7.1 absorbs drive forces emanating from the motor 1 and the second bracket mount 7.2 absorbs braking forces emanating from the brake 2. In addition, the two bracket mounts 7.1, 7.2, absorb forces emanating from the drive pulleys 3, 3′. Advantageously, the two drive pulleys 3, 3′ are arranged symmetrically to the left and right of the horizontal connector of the car guides 5, 5′.

In addition, in the embodiments according to FIGS. 5 to 8—where at least one deflecting roller 15, 15′ and 16, 16′ is provided in the region above the counterweight 12 and/or substantially above the car 11—forces emanating from this deflecting roller can be absorbed by the crossbeam 8. Advantageously, this deflecting roller is fastened to the crossbeam 8 or to the bracket 7. Pairs of the deflecting rollers 15, 15′, 16, 16′ are advantageously arranged symmetrically to the left and right of the horizontal connector of the car guides 5, 5′. Due to the number and position of the deflecting rollers, a flexibility in the arrangement of the drive motor 1 on the area of the triangles T, T′ is made possible. In particular, a high degree of utilization of the shaft volume can be realized wherein a dead volume is largely avoided. In addition, the arrangement of the drive motor can be flexibly adapted to predetermined shaft relationships even in the case of modernizing operations, which flexibility thus enables use of standard parts and avoids costly special solutions.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation having a car and a counterweight connected by a drive means and movable in a shaft comprising:
a pair of car guides adapted to be mounted in the shaft;
a pair of counterweight guides adapted to be mounted in the shaft;
a crossbeam attached to said counterweight guides and to at least one of said car guides; and
a drive motor mounted on said crossbeam and coupled to a pair of drive pulleys adapted for engaging the drive means to move the car and the counterweight in the shaft.

2. The elevator installation according to claim 1 wherein said drive pulleys are arranged on opposite sides of an imaginary line horizontal connector of said car guides.

3. The elevator installation according to claim 1 wherein said drive pulleys are operatively connected by a shaft with said drive motor and a brake.

4. The elevator installation according to claim 3 wherein said drive pulleys are arranged between said drive motor and said brake on said shaft.

5. The elevator installation according to claim 3 wherein said drive motor and said brake are mounted on a bracket fastened to said crossbeam.

6. The elevator installation according to claim 5 wherein said bracket is mounted at a center region of said crossbeam.

7. The elevator installation according to claim 5 wherein said drive pulleys are arranged substantially in a region within an enclosure of said bracket.

8. The elevator installation according to claim 1 wherein said counterweight guides and said at least one of said car guides are positioned at apices of a substantially horizontal triangle and said crossbeam is fastened at end regions to said counterweight guides and at a center region to said at least one of said car guides.

9. The elevator installation according to claim 1 wherein said car guides and counterweight guides are arranged to extend substantially vertically in the shaft and said crossbeam is arranged to extend substantially horizontally in the shaft.

10. An elevator installation having a car and a counterweight connected by a drive means and movable in a shaft comprising:
an elevator shaft;
an elevator car movable in said shaft along a pair of car guides mounted in said shaft;
a counterweight movable in said shaft along a pair of counterweight guides mounted in said shaft;
a crossbeam attached to said counterweight guides and to at least one of said car guides; and
a drive motor mounted on said crossbeam for moving said car and said counterweight in said shaft.

11. The elevator installation according to claim 10 including at least two drive means connecting said car and said counterweight, each said drive means having two ends and each of said ends being fixed to one of a wall of the shaft, a ceiling of the shaft, one of said counterweight guides, one of said car guides, said crossbeam, said counterweight and said car.

12. The elevator installation according to claim 10 including at least two drive means connecting said car and said counterweight and wherein said drive means are belts.

13. The elevator installation according to claim 10 wherein said car is suspended in said shaft with a 2:1 ratio and said drive motor is arranged in a region above a travel path of said counterweight in said shaft.

14. The elevator installation according to claim 10 wherein said car is suspended in said shaft with a 2:1 ratio and said drive motor is arranged in a region above a travel path of said car.

15. The elevator installation according to claim 10 wherein said car is suspended in said shaft with a 2:1 ratio and said drive motor is arranged in a region above a travel path of said car and a travel path of said counterweight.

16. The elevator installation according to claim 10 wherein said car is suspended in said shaft with a 1:1 ratio and said drive motor is arranged in a region above a travel path of said car.

17. A method of arranging a drive motor of a elevator installation in an elevator shaft for moving a car and a counterweight comprising the steps of:
a) providing a crossbeam and fastening the crossbeam to a pair of counterweight guides and at least one of a pair of car guides in the elevator shaft;
b) providing a drive motor and mounting the drive motor on the crossbeam; and
c) providing two drive pulleys and coupling the drive pulleys to the drive motor on opposite sides of an imaginary line horizontal connector extending between said car guides.

18. The method according to claim 17 wherein the counterweight guides and the at least one car guide are positioned at apices of a substantially horizontal triangle and said step a) is performed by fastening end regions of the crossbeam to respective ones of the counterweight guides.

19. The method according to claim 18 wherein said step a) is performed by fastening a center region of the crossbeam to the at least one car guide.

20. The method according to claim 18 wherein said step b) is performed by mounting the drive motor in the area of the triangle substantially above one of the counterweight and the car.
